(19) United States
(12) Patent Application Publication
(10) Pub. No.: US 2015/0015400 A1
(43) Pub. Date: Jan. 15, 2015

(54) Computer-Aided System Detecting Operator Fatigue (CASDOF)

(71) Applicant: L&P PROPERTY MANAGEMENT COMPANY, South Gate, CA (US)

(72) Inventors: Ronald Dean Davis, Joplin, MO (US); Travis Brummett, Carthage, MO (US); Jason B. Turner, Joplin, MO (US); Caleb Browning, Carthage, MO (US)

(21) Appl. No.: 14/325,529

(22) Filed: Jul. 8, 2014

Related U.S. Application Data
(60) Provisional application No. 61/845,153, filed on Jul. 11, 2013.
(60) Provisional application No. 61/924,509, filed on Jan. 7, 2014.

(51) Int. Cl. G08B 21/06

(52) U.S. Cl. CPC G08B 21/06
USPC 340/575

(57) ABSTRACT

A system for monitoring operator alertness. The system includes a sensor for detecting a head position property of a head of an operator and a controller in operative communication with the sensor. The controller is configured to collect a first plurality of time points of the head position property of the head of the operator, determine a baseline of the head position property of the head of the operator based on the first plurality of time points, collect a second plurality of time points of the head position property of the head of the operator, determine an operating condition of the head position property of the head of the operator based on the second plurality of time points, and evaluate the alertness of the operator based on a comparison of the operating condition to the baseline to identify a period of head stillness.

### CROSS-REFERENCE TO RELATED APPLICATIONS

This application claims priority to U.S. Provisional Patent Application Nos. 61/845,153 filed Jul. 11, 2013, and 61/924,509 filed Jan. 7, 2014, each of the contents of which is incorporated herein by reference in its entirety.

### BACKGROUND

The present invention relates to methods and systems for monitoring alertness of an operator of a machine such as a vehicle.

There is a need for a reliable system that can monitor operators of moving or stationary machinery such as vehicles or industrial systems.

### SUMMARY

In one embodiment, the invention provides a system for monitoring operator alertness. The system includes a sensor for detecting a head position property of a head of an operator and a controller in operative communication with the sensor. The controller is configured to collect a first plurality of time points of the head position property of the head of the operator, determine a baseline of the head position property of the head of the operator based on the first plurality of time points, collect a second plurality of time points of the head position property of the head of the operator, determine an operating condition of the head position property of the head of the operator based on the second plurality of time points, and evaluate the alertness of the operator based on a comparison of the operating condition to the baseline to identify a period of head stillness.

In another embodiment the invention provides a method of monitoring alertness of an operator. The method includes the steps of: sensing a head position property of a head of an operator; collecting a first plurality of time points of the head position property of the head of the operator; determining a baseline of the head position property of the head of the operator based on the first plurality of time points; collecting a second plurality of time points of the head position property of the head of the operator; determining an operating condition of the head position property of the head of the operator based on the second plurality of time points; and evaluating the alertness of the operator based on a comparison of the operating condition to the baseline to identify a period of head stillness.

In yet another embodiment the invention provides a method of monitoring alertness of an operator. The method includes the steps of: sensing a head position property of a head of an operator at a plurality of time points; generating an array of head acceleration values based on the head position property values for the plurality of time points; determining a variation of the array of head acceleration values; combining the variation of the array of head acceleration values with a predetermined lower bound limit to produce a cumulative sum value; and, if the cumulative sum value is greater than zero for a predetermined period of time and the variation of the array of head acceleration values is zero, taking an action based on the alertness of the operator.

Other aspects of the invention will become apparent by consideration of the detailed description and accompanying drawings.

### BRIEF DESCRIPTION OF THE DRAWINGS

FIG. 1 shows a graph of operator head movements under test conditions.

FIG. 2 shows a diagram of one construction of an operator monitoring system.

FIG. 3 shows an array of ultrasonic sensors for use in constructions of an operator monitoring system.

FIG. 4 shows a flow chart with a series of steps for establishing thresholds used to differentiate between alert and fatigued states according to constructions of an operator monitoring system.

FIG. 5 shows a flow chart with a series of steps for relating incoming data to normal behavior.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The Computer-Aided System Detecting Operator Fatigue (CASDOF) system is a collection of electronic components for monitoring an operator of various machines, vehicles, or other systems for reduced states of operator awareness. In various embodiments the system may include three parts. First, the sensor array collects data related to the operator's movements. Second, the computing platform uses a unique combination of algorithms, processing the sensor array data. Third, an interface will output any signs of fatigue or reduced alertness. The system may then use these signs to inform the operator and/or record the event into a database for future analysis.

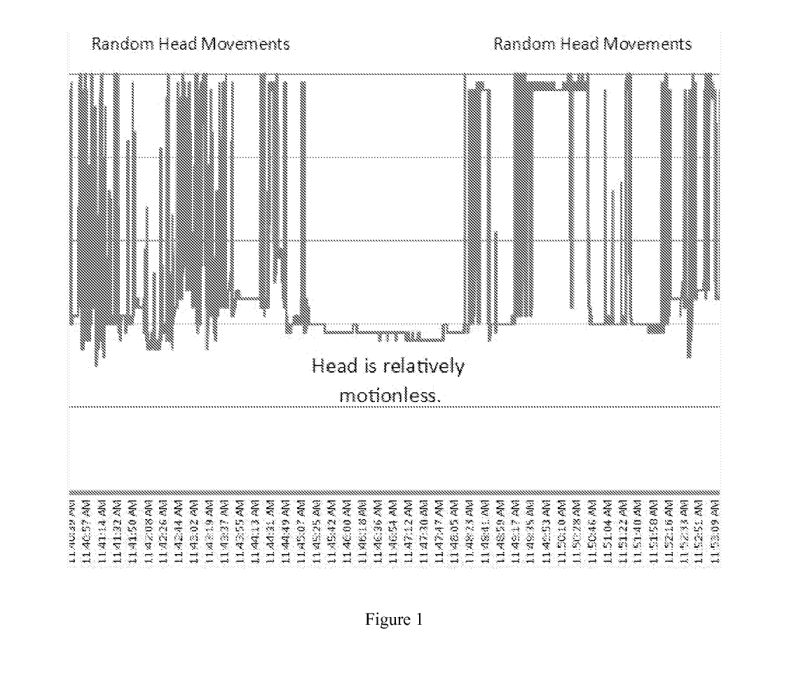

The system collects and evaluates sensor data from the operator, typically from the operator's head (e.g. one or more of various head position properties such as location, velocity, and acceleration) to assess the level of alertness of the operator. The present inventors have discovered that an early warning of operator fatigue or drowsiness is indicated when the operator's head becomes still for a period of time. The expression “head stillness” as used herein indicates reduced head movement and/or complete lack of motion. While the inventors' previous work has shown that periodic or quasi-periodic head movements can be used as indicators of operator fatigue or drowsiness (Wu et al., US 2012/0169503, incorporated herein by reference in its entirety), the periods of head stillness that are identified using the present techniques occur prior to the periodic or quasi-periodic head movements identified in the Wu et al. publication and therefore provide a relatively early indication of operator drowsiness or fatigue. FIG. 1 shows operator head position over a 12.5 minute time period, where the operator is a pilot in a flight simulator. In FIG. 1 the operator is beginning to show fatigue and drowsiness, as indicated by the approximately 3-minute period in which the operator's head is relatively still. Before and after the period of stillness the operator's head exhibits apparently random head movements. However, the periods of head stillness such as that shown in FIG. 1 have been identified by the present inventors as an early indication of drowsiness.

The procedures disclosed herein reliably identify these periods of head stillness and distinguish head stillness periods which are indicative of drowsiness and fatigue from false positive events. In various embodiments, fatigue or drowsiness is indicated when an operator's head remains relatively still for about 1 second, about 2 seconds, about 3 seconds, about 4 seconds, about 5 seconds, about 10 seconds, about 15 seconds, about 20 seconds, about 30 seconds, about 1 minute, about 2 minutes, about 3 minutes, about 5 minutes, about 10 minutes, or for longer periods. The periods of head stillness may include some head movements but on average the amount of head movement during these periods is greatly reduced compared to when the operator is alert. The given time period during which operator head stillness is assessed may be about 10 seconds, about 20 seconds, about 30 seconds, about 1 minute, about 2 minutes, about 3 minutes, about 4 minutes, about 5 minutes, about 10 minutes, or about 15 minutes. The given time period may be evaluated using the mathematical equations described below, where the amount of time that is factored into an operator alertness determination is governed at least in part by the values of variables in the equations.

The time period of head stillness may vary from one set of conditions to another based on factors such as the particular driver and whether the system is stationary or moving and, for a system in motion, how stable the system is. Therefore, in certain embodiments a baseline of head movement is determined at a point when the operator is likely to be alert (e.g. at the beginning of a shift) and subsequent measurements (that is, the operating condition of the head position property) are compared to the baseline measurement of the head position property. The baseline measurements of head movements of an alert operator are a collection of data that may be used as a control or reference against which subsequent operating condition head position properties are measured.

The CASDOF system may be used in a wide variety of situations. While the primary applications may include automotive and aviation sectors, the system may be used in other industries as well. For example, shipping industries would also benefit from this system (e.g. trucking, trains, marine, etc.). Other uses could be found in the mining industry, air traffic control towers, security stations, and cabs of cranes and other construction or heavy equipment. In general, the CASDOF system may be useful in situations in which an operator must remain alert and be in a relatively stationary position (e.g. sufficiently stationary that their head position can be tracked over time) relative to the operator's controls.

One or more sensors may be situated at one or more locations in the vehicle or other location where the system is employed, including on or in the headrest or other portions on or near where the operator is located such as the seat or seatback, a control panel or computer interface, or, for vehicles or other similar environments, the dashboard, steering wheel, visor, or roof (FIG. 2). In some embodiments in which an operator may not have a seat (e.g. the operator stands while working) or does not have a seat with a back (e.g. the operator sits on a backless bench or stool), the sensor(s) may be located in a control panel, roof structure, or other nearby location that places the sensor(s) in a position to collect head position property data for the operator's head. During use, the sensor(s) collect one or more of a location/position, velocity, and acceleration of the operator's head. In FIG. 2, an exemplary system includes a central processing unit (“CPU”) (which may take the form of a microprocessor or similar device) and may be located in a number of different locations, including the locations designated P1, P2, and P3. The one or more sensors 22 are in communication with the CPU. The CPU may also be located in other locations within the system (e.g. in the vehicle or other location in which the system is installed) or remote from the system.

The data that is collected may be transmitted (e.g. by wired or wireless communication mechanisms) to a computing system (such as the CPU), for example within the local environment such as a vehicle, although the data could also or instead be transmitted to a remote location for analysis and monitoring. The computing system may also be housed in a single unit with the one or more sensors. The computing system may be integrated into or be housed along with other computing systems or components in which the system is used. For example, in the case of a vehicle the computing system may be located in or under the dashboard, the seat, or other suitable location (FIG. 2). The computing system can include a processor, memory, communication mechanisms (e.g. for receiving data from the one or more sensors as well as transmitting signals to the driver or other vehicle systems, and/or to a remote location), other input/output mechanisms (e.g. for inputting software updates, changing settings, troubleshooting, notifying the driver of inattentiveness/drowsiness or of possible system errors), and computer-readable media (e.g. flash memory or a hard drive to name a few possibilities) for storing program and data information and for maintaining a log of collected and analyzed data.

When it is determined that the operator is fatigued, drowsy, or otherwise lacking attentiveness or alertness, steps are taken to alert the operator using a signaling device, e.g. by making a sound using a speaker or other audio device, flashing a light, vibrating a component (e.g. seat or steering wheel), or, particularly on a land-based vehicle, automatically applying the brakes to catch the operator's attention to his or her fatigued or drowsy state. Depending on the type of alert that is generated and the environment in which the system is installed, the alerting mechanism may be located in one or more locations to gain the operator's attention, such as on or in portions of the seat or seatback including the headrest, the control panel or computer interface, or, for a vehicle, the dashboard, the steering wheel, the visor, or the roof (e.g. see locations of the one or more sensors in FIG. 2). In other embodiments (e.g. other than a road-based vehicle), alerting mechanisms may be located on or near control panels and/or within hand controls that the operator is likely to be holding.

The CASDOF system may use a variety of sensor technologies (including combinations of technologies) to provide the necessary data needed for the algorithms to detect fatigue or drowsiness. The main metric needed by the algorithms is the acceleration of the operator's head. The acceleration data may be obtained in any number of ways. In various embodiments accelerometers may be used to obtain acceleration data, however, this embodiment is potentially limited by the fact that these sensors must be worn by the operator and thus may be restricted in implementations in which the operator is already required or accustomed to using headgear (e.g. a hard hat). Nevertheless, any of a number of sensors that can measure acceleration and which are safe for monitoring human movement may be used.

Instead of, or in addition to, acceleration measurements, operator head velocity may also be measured and the velocity measurements may be used to calculate acceleration over time. In some embodiments, velocity can be measured by using the Doppler Effect. For example, light or sound may be emitted at a known frequency and the change of that emitted wave's frequency reflected by the operator's head may be used to determine velocity of the reflecting object. Other sensors that measure position, velocity, or acceleration and which are safe for monitoring humans may also be used.

In certain embodiments, head distance or position measurements may be used to calculate velocity over time and then acceleration over time. In certain embodiments, head distance measurements may be determined using time-of-flight measurements. Time-of-flight measurements involve sending out some type of energy (e.g. sound, light, etc.) and measuring the amount of time which elapses before the energy's reflection is detected. One example of time-of-flight measurement is sonar. In a sonar system, a short pulse of acoustic energy is emitted from a transducer and the time necessary for the pulse to be reflected back to the source is used to determine the distance between the source and the reflective object. In other embodiments, head distance sensors may use light. In still other embodiments, head distance may be calculated using structured light 3D scanning. In these embodiments, a pattern of light is projected onto a location and a scanner (e.g. an infrared imaging system) uses the deformation of that pattern to determine depth of various objects in that scene. In yet other embodiments, capacitive displacement sensors may also be used to detect head distance or position. In general, any sensor system which is capable of determining distances to targets and is safe for monitoring humans can be used.

The placement of these various sensors is dependent on several factors. As discussed above, the sensors (depending on which type(s) are used and the system in which they are installed) may be placed in a seat's headrest, on the operator's console, in the ceiling of the operator's cab, in a driver's rear view mirror, above an operator's windshield, etc. (see, e.g., FIG. 2). Given that the sensors used must be able to measure the operator's head position properties, proximity or line of sight may be required depending on the sensing technology. With this in mind, the sensors may be placed in a number of positions within the vicinity of the operator's head or within the operator's compartment.

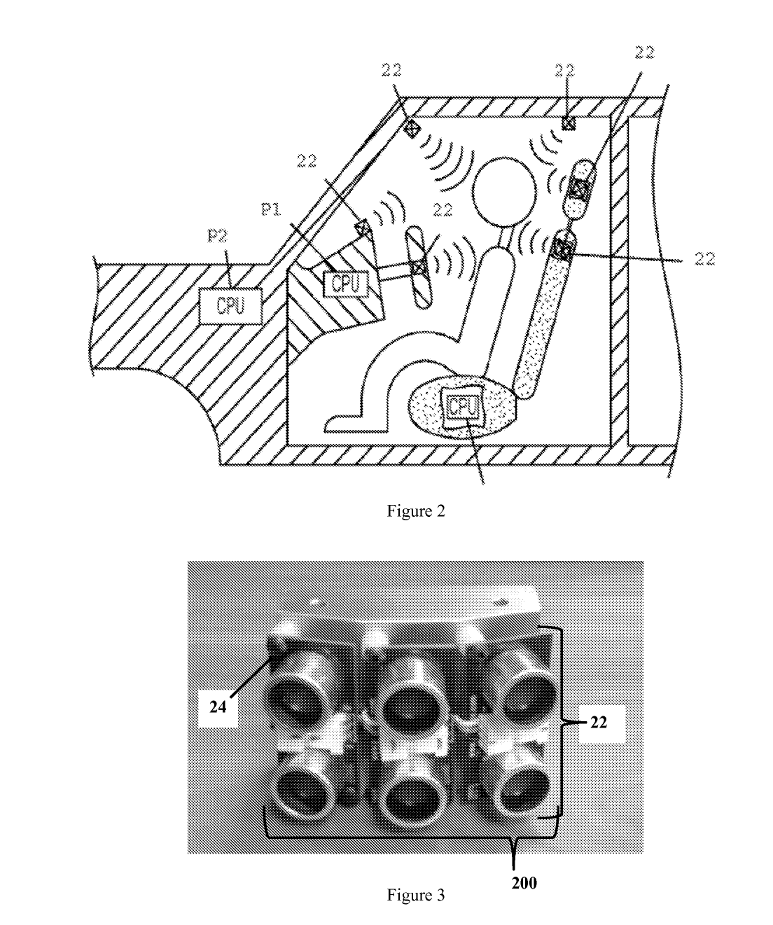

One particular embodiment of a sensor array 200 which has been used in testing combines three ultrasonic sensors 22, increasing the field of view for distance measuring. Each sensor 22 in this embodiment includes a small circuit board 24 having an emitter and receiver. The three circuit boards are mounted vertically to an aluminum block (FIG. 3).

In various embodiments, the sensor array translator unit selects the best measurement of the three sensors. Each sensor is activated sequentially and its result is compared to the last result taken from that sensor. If the current measurement exceeds the last measurement by 10 cm or more, the current and previous measurements are averaged together. Otherwise, the current measurement is considered by itself (i.e. without averaging). The shortest/closest of the three sensors' measurements is then considered to be the valid measurement unless the reading is out of range. If out of range, the previous valid measurement may be used for up to three time points. After using a previous valid measurement for three time sequential time points, the out of range measurement is used and is compared to the readings from the other sensors. The final valid measurement is averaged with the last valid measurement and then sent to the algorithm as the official measurement for that time period.

Procedures for obtaining and evaluating sensor data will vary between system implementations depending on the type of sensor that is used and the operating environment.

The CASDOF system may not run at all times. In some embodiments, the system will activate after certain criteria are met, where the criteria may depend on the particular application. For example, in an environment involving a moving vehicle, the CASDOF system may not begin operation until the vehicle reaches a certain speed. Similarly, in an aviation environment, the system may activate after a cruising altitude has been reached. In still other embodiments, the CASDOF system may not be activated until a certain amount of time has elapsed since the vehicle or other system has started operation or has had a new operator take control. In various embodiments, the end user may determine what criteria are needed and how these conditions are monitored by the CASDOF system.

After the system is activated, a steady stream of data is received from the sensor array; using this data, the CASDOF system may begin by collecting and processing data corresponding to head position properties of a normal, alert operator, particularly in those embodiments in which a baseline is acquired and used for subsequent analyses.

In various embodiments, head position property data may be collected at various time intervals. A variable called deltaT (typical values are 10-100 milliseconds) determines how often a new data point is recorded from one or more sensors. In various embodiments, deltaT is about 10 msec, about 20 msec, about 50 msec, about 100 msec, about 0.5 sec, about 1 sec, about 5 sec, about 10 sec, about 30 sec, about 1 minute, or other suitable time values.

In some embodiments, sensors are used to determine a distance from the sensor to the operator's head. The distance data from the sensors may then be used to calculate velocity points and the velocity points may be used to calculate acceleration points using the following formulas:

$$Velocity = \frac{Δ Distance}{delta T}$$

$$Acceleration = \frac{Δ Velocity}{delta T}$$

As discussed above, the present inventors have identified a period of operator head stillness as being an indicator of fatigue or drowsiness. Thus, in various embodiments the CASDOF system analyzes head position property data obtained from sensor readings to identify one or more periods of head stillness.

In certain embodiments a baseline of head position property information may be obtained from an operator under alert conditions and then incorporated into the assessment of operator alertness at later times. Thus, in some embodiments a Lower Bound Limit (LBL) is determined based on the baseline head position property data obtained from an operator during an alert phase (e.g. when an operator begins a shift). The LBL is determined as described below using alert operator data and is then used to process head position property data obtained from subsequent measurements during the operator's shift (i.e. operating condition head position property data) in order to evaluate the alertness of the operator. In some embodiments, additional processing may be performed to reduce or eliminate false positives, i.e. momentary periods of head stillness which may cause the processed data to generate a value that appears to indicate operator drowsiness but which may not be sustained for long enough to indicate actual drowsiness or fatigue. In certain embodiments, the LBL value may be a predetermined value (e.g. based on factors such as the type of machine on which the CASDOF system is installed and typical operator values) that is used for processing and analysis of data collected based on the operator's head movements to evaluate potential drowsiness.

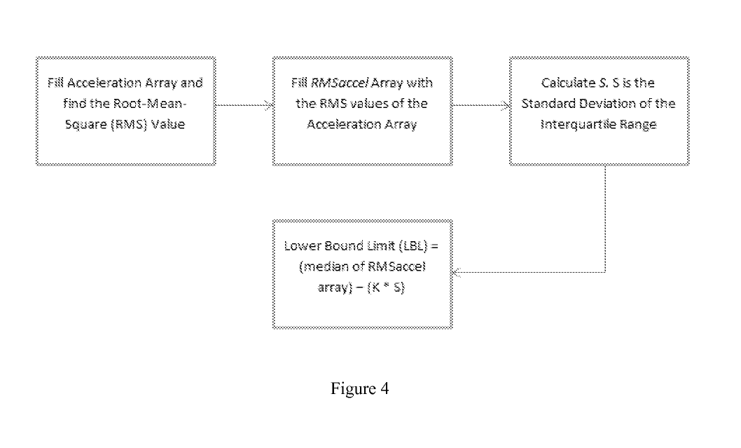

The following is a list of steps that may be used to establish the thresholds for differentiating between alert and fatigued states (see FIG. 4). In some embodiments, the variation of operator head acceleration values (e.g. root-mean-square or standard deviation) is determined for a series of acceleration values. The variation values may then be used to determine a lower bound limit (LBL), which provides a point of reference for the amount of head movement of an operator during an alert phase.

In one embodiment, the CASDOF system includes an Acceleration array for storing operator head acceleration values and an RMSaccel array for storing a Root-Mean-Square of the Acceleration array values using the following steps (see also FIG. 4):

a) Fill the Acceleration array with acceleration values and use this data to fill the RMSaccel array:
Number of elements in array determined by Sliding Window parameter (typical value is 100, although in various embodiments the value may vary from 10-1000);
Calculate the Root-Mean-Square (RMS) value of the Acceleration array and store in RMSaccel array;

$${RMSaccel}_{x} = \sqrt{( \frac{1}{n} ) ( {\sum }_{i = 0}^{n} [ Acceleration {array}_{i}^{2} ] )}$$

$$n = Sliding Window , x = an element in the array$$

b) After another deltaT time period has elapsed, delete the first element of the Acceleration array and shift all values down, filling the last element with a new acceleration value calculated from the next data point received from the sensor. This represents a first-in, first-out (FIFO) scheme for the arrays that will be used again later.

c) Repeat a) and b) until RMSaccel array is full (i.e. add a new element to the Acceleration array at each deltaT time point), removing the oldest acceleration value and shifting the remaining values down, and calculating a new value to add to the RMSaccel array based on the current version of the Acceleration array.
The number of elements in the RMSaccel array is determined by the ThresholdSamples parameter (typically 3000, although other numbers greater or less than 3000 are also possible, for example anywhere from 100-10,000)

d) Calculate standard deviation S_{RMSaccel} of the RMSaccel array.
S is the standard deviation derived from the interquartile range (IQR)
Calculate the 75 percentile value (75% ile) and 25 percentile value (25% ile) of the RMSaccel array. The 25 percentile and 75 percentile values are the values from the RMSaccel array that represent the cutoff points for the bottom and top quartiles of the RMSaccel array values. Subtract the 25% ile RMSaccel value from the 75% ile RMSaccel value—this difference represents the interquartile range (IQR). Because the interquartile range of a normally-distributed random variable is about 1.35 times its standard deviation, one can divide the IQR by 1.35 to obtain the standard deviation of the IQR:

$${S}_{RMSaccel} = \frac{75 \% ile of RMSaccel - 25 \% ile of RMSaccel}{1.35}$$

e) Calculate LBL or Lower Bound Limit
LBL=Multiply S_{RMSaccel} and variable K and subtract result from the median of the RMSaccel array

LBL=(Median of RMSaccel array)−(S_{RMSaccel}*K)
K is used to tune the sensitivity of the algorithm (typical values for K are in the range of 0.1-3.0, although higher or lower values, e.g. from 0.01 to 10.0, are also possible)

The LBL will be compared to future behavior as discussed below.

In various embodiments other methods of evaluating operator alertness based on head movements are also possible, such as calculating an RMS value of the RMSaccel array and scaling it for use as a threshold. However, in some cases these alternative methods may result in false positives (erroneously indicating drowsiness when the driver is alert) and/or false negatives (failing to identify a drowsy state when the driver is in fact drowsy).

In some embodiments, the acceleration array can be processed by calculating a Standard Deviation instead of the RMS. The standard deviation formula is similar to RMS, with the difference that, instead of squaring each element, the array's mean value is subtracted from each element and then squared (see equation below). The RMS formula is based on the assumption that the mean value of the array is zero. The accelerations of the operator's head will average to zero over time, so both formulas are expected to produce similar results in most instances.

$$s = \sqrt{( \frac{1}{N - 1} ) {\sum }_{i = 1}^{N} {( {x}_{i} - \overline{x} )}^{2}} N = Sliding Window$$

In general, an operator is considered fatigued or drowsy when their head movements trend toward zero. The cumulative sum method is an additional component according to embodiments of the CASDOF system for evaluating alertness of the operator and in particular for identifying when operator head movements reach a point that indicates possible fatigue or drowsiness. The cumulative sum method allows the monitoring of the RMSaccel for any drift or shifting of the operator's head movements from the baseline behavior. Use of a cumulative sum permits the system to follow trends of head stillness even if these are occasionally interspersed with short periods of head movements.

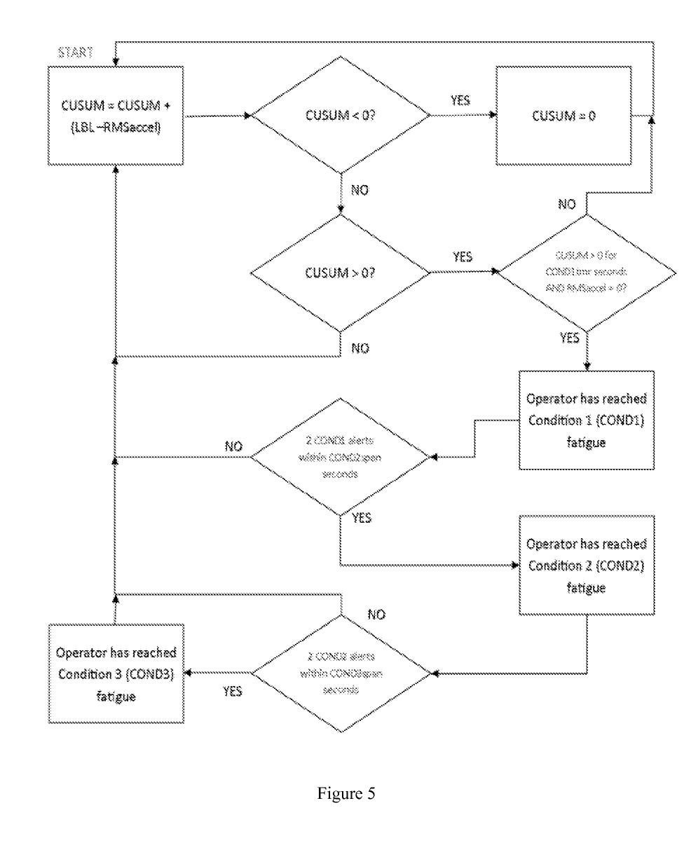

The RMSaccel will continue to be calculated every deltaT period based on subsequent measurements of the operator's head position property, i.e. based on the operating condition of the head position property. The RMSaccel value will be compared to the LBL using the following steps (FIG. 5):

a) Set CUSUM to zero. CUSUM is a variable that acts as an accumulator.

b) Subtract current RMSaccel from the LBL. Add result to CUSUM. If CUSUM is less than zero, reset CUSUM to zero. If CUSUM is greater than ActionLimit, then reset CUSUM to FIR (fast initial response). H allows tuning of the action limit and its typical value is 0.5, although higher or lower values, e.g. between 0 and 1, are also possible.

$$ActionLimit = H * {S}_{RMSaccel}$$

$$FIR = \frac{ActionLimit}{2}$$

c) If CUSUM is greater than 0 for more than COND1tmr seconds and RMSaccel is 0, the operator's fatigue level has reached Condition 1 (COND1). An alert could be sent to the interface system. COND1 tmr has typical values between 1.5 to 6 seconds, although higher or lower values, for example from 0.5 to 20 seconds, are also possible.

d) If a COND1 alert occurs within COND2span seconds of a previous COND1 alert ending, the operator's fatigue level has reached Condition 2 (COND2). An alert could be sent to the interface system. COND2span has typical values between 60-90 seconds, although higher or lower values, for example from 10 to 180 seconds, are also possible.

e) If a COND2 alert occurs within COND3span seconds of a previous COND2 alert ending, the operator's fatigue level has reached Condition 3 (COND3). An alert could be sent to the interface system. COND3span was determined by looking at the time gaps between COND2's over entire data sets. The median of these time gaps was calculated and then the standard deviation was calculated using the formula mentioned earlier:

$${S}_{Time Gaps} = \frac{75 \% ile of Time Gaps - 25 \% ile of Time Gaps}{1.35}$$

COND3span was then calculated to be the Median of the Time Gaps plus 2 times S_{Time Gaps} and could contain nominal values of 3600-5000 seconds, although higher or lower values, for example from 1000 to 10,000 seconds, are also possible.

COND3span=(Median of Time Gaps)+(2*S_{Time Gaps})

Steps a)-e) may be repeated every deltaT time period until the CASDOF system is shut down, e.g. by the end-user specified criteria. In some embodiments involving vehicles, spending a predetermined time below a predetermined speed may disable the CASDOF system. In other embodiments, shutting the machine or vehicle off could shut down the CASDOF system. The values of variables including deltaT, Sliding Window (i.e. the number of elements in Acceleration array), ThresholdSamples (i.e. the numbers of elements in the RMSaccel array), K, H, COND1tmr, COND2span, and COND3span are determined empirically based on results obtained with test data in order to minimize false positive and false negative results.

In other embodiments, the system may be configured to simply monitor a distance to the operator's head to determine if it stays constant for a predetermined amount of time. This approach may provide a general indication of operator fatigue and drowsiness. However, this, along with other simplified methods, may result in false positive warnings of drowsiness which, if they occur too often, might lead operators to ignore or disengage the system.

Once a COND1, COND2, and/or COND3 alert has been detected, the CASDOF system may send an alert either to the operator (e.g. using mechanisms such as those discussed below) and/or to a remote location (e.g. a base station, dispatch, headquarters, etc) in several different ways. In various embodiments, the operator may be alerted when any Condition level is reached; in certain embodiments, the operator may only be alerted when a second or third Condition level is reached; in particular embodiments, the operator may receive different warnings depending on the Condition level that is reached, e.g. lights, sounds, vibrations, etc. In other embodiments, additional Condition levels may be added which are triggered based on factors such as whether another Condition level was reached and how long it has been since the Condition level was reached.

In various embodiments, methods for alerting an operator include turning on lighted indicators located on the operator's control panel, activating a sound emitting device, engaging a seat massage system, or, for land-based vehicle installations, applying brake pressure or vibrating the steering wheel.

The CASDOF system may also transmit information to a control unit located on the machine or vehicle. The end-users control unit could then activate related alerting mechanisms. Likewise, the CASDOF system could send the data in a wired or wireless manner to a central database for storage and possible later analysis.

Various features and advantages of the invention are set forth in the following claims.

What is claimed is:

1. A system for monitoring operator alertness, comprising:
a sensor for detecting a head position property of a head of an operator; and
a controller in operative communication with the sensor, the controller configured to
collect a first plurality of time points of the head position property of the head of the operator,
determine a baseline of the head position property of the head of the operator based on the first plurality of time points,
collect a second plurality of time points of the head position property of the head of the operator,
determine an operating condition of the head position property of the head of the operator based on the second plurality of time points, and
evaluate the alertness of the operator based on a comparison of the operating condition to the baseline to identify a period of head stillness.

2. The system of claim 1, wherein, to determine a baseline of the head position property of the operator, the controller is further configured to determine an acceleration value of the head of the operator and store the acceleration value in a baseline acceleration array.

3. The system of claim 2, wherein the controller is further configured to determine a root-mean-square value of the baseline acceleration array to produce a baseline RMS acceleration array.

4. The system of claim 3, wherein the controller is further configured to calculate a standard deviation and lower bound limit from the baseline RMS acceleration array.

5. The system of claim 4, wherein, to determine an operating condition of the head position property of the operator, the controller is further configured to determine an acceleration value of the head of the operator and store the acceleration value in an operating condition acceleration array.

6. The system of claim 5, wherein the controller is further configured to determine a root-mean-square value of the operating condition acceleration array to produce an operating condition RMS acceleration array.

7. The system of claim 5, wherein the controller, to evaluate the alertness of the operator, is further configured to
determine a current root-mean-square value of the operating condition acceleration array,
subtract the current root-mean-square value of the operating condition acceleration array from the lower bound limit to produce a result,
add the result to an accumulator variable to produce a new accumulator variable value, and
evaluate an alertness based on the new accumulator variable value.

8. The system of claim 1, wherein the controller is further configured to take an action based on the alertness of the operator.

9. The system of claim 8, wherein the action includes at least one of generating an alarm and recording the alertness of the operator in a database.

10. The system of claim 1, wherein the head position property is selected from a location, a velocity, and an acceleration of the head of the operator.

11. The system of claim 1, wherein the operator is operating a vehicle.

12. The system of claim 1, wherein the operator is operating a vehicle and wherein the vehicle is selected from a truck, an automobile, a train, an airplane, a spacecraft, and a boat.

13. The system of claim 1, wherein the operator is an air traffic controller, a security guard, or a crane operator.

14. The system of claim 1, wherein the time points are collected at 0.1 second intervals.

15. A method of monitoring alertness of an operator, the method comprising the steps of:
sensing a head position property of a head of an operator;
collecting a first plurality of time points of the head position property of the head of the operator;
determining a baseline of the head position property of the head of the operator based on the first plurality of time points;
collecting a second plurality of time points of the head position property of the head of the operator;
determining an operating condition of the head position property of the head of the operator based on the second plurality of time points; and
evaluating the alertness of the operator based on a comparison of the operating condition to the baseline to identify a period of head stillness.

16. The method of claim 15, determining a baseline of the head position property of the operator further comprises determining an acceleration value of the head of the operator and storing the acceleration value in a baseline acceleration array.

17. The method of claim 16, further comprising determining a root-mean-square value of the baseline acceleration array to produce a baseline RMS acceleration array.

18. The method of claim 17, further comprising calculating a standard deviation and lower bound limit from the baseline RMS acceleration array.

19. The method of claim 18, determining an operating condition of the head position property of the operator further comprises determining an acceleration value of the head of the operator and storing the acceleration value in an operating condition acceleration array.

20. The method of claim 19, further comprising determining a root-mean-square value of the operating condition acceleration array to produce an operating condition RMS acceleration array.

21. The method of claim 19, wherein evaluating the alertness of the operator further comprises
determining a current root-mean-square value of the operating condition acceleration array,
subtracting the current root-mean-square value of the operating condition acceleration array from the lower bound limit to produce a result,
adding the result to an accumulator variable to produce a new accumulator variable value, and
evaluating an alertness based on the new accumulator variable value.

22. The method of claim 15, further comprising taking an action based on the alertness of the operator.

23. The method of claim 22, wherein the action includes at least one of generating an alarm and recording the alertness of the operator in a database.

24. The method of claim 15, wherein the head position property is selected from a location, a velocity, and an acceleration of the head of the operator.

25. The method of claim 15, wherein the operator is operating a vehicle.

26. The system of claim 15, wherein the operator is operating a vehicle and wherein the vehicle is selected from a truck, an automobile, a train, an airplane, a spacecraft, and a boat.

27. The method of claim 15, wherein the operator is an air traffic controller, a security guard, or a crane operator.

28. The method of claim 15, wherein the time points are collected at 0.1 second intervals.

29. A method of monitoring alertness of an operator, the method comprising the steps of:
sensing a head position property of a head of an operator at a plurality of time points;
generating an array of head acceleration values based on the head position property values for the plurality of time points;
determining a variation of the array of head acceleration values;
combining the variation of the array of head acceleration values with a predetermined lower bound limit to produce a cumulative sum value; and
if the cumulative sum value is greater than zero for a predetermined period of time and the variation of the array of head acceleration values is zero, taking an action based on the alertness of the operator.

30. The method of claim 29, wherein the action includes at least one of generating an alarm and recording the alertness of the operator in a database.

31. The method of claim 29, wherein the variation of the array of head acceleration values comprises a root-mean-square of the array of head acceleration values.

32. The method of claim 29, wherein the predetermined lower bound limit is determined based on head position property measurements of the operator at an earlier time period.

33. The method of claim 29, wherein the predetermined period of time is between 1 and 10 seconds.
